(19) United States
(12) Patent Application Publication
(10) Pub. No.: US 2010/0121797 A1
(43) Pub. Date: May 13, 2010

(54) STANDOFF DETECTION FOR NITRIC ACID

(75) Inventors: Saad J. Bedros, West Saint Paul, MN (US); Kwong Wing Au, Bloomington, MN (US); Darryl Busch, Eden Prairie, MN (US)

Correspondence Address: HONEYWELL/MUNCK;Patent Services, 101 Columbia Road, P.O. Box 2245, Morristown, NJ, 07962-2245, US

(73) Assignee: Honeywell International Inc., Morristown, NJ (US)

(21) Appl. No.: 12/269,569

(22) Filed: Nov. 12, 2008

(51) Int. Cl. G06N 3/02; G06N 5/02; G06F 15/18; G06F 17/14; G01N 31/00

(52) U.S. Cl. 706/20; 706/46; 706/25; 708/404; 702/27

(57) ABSTRACT

In one embodiment, a method is disclosed that includes obtaining at least one measurement in a spectral domain of a sample and computing one or more measurements of the salient features in the spectral domain. The salient features correspond to at least one peak within the spectral domain. This method also includes classifying the computed salient features against a feature signature of nitric acid. In addition, this method includes determining if the chemical is present in the sample.

### GOVERNMENT FUNDING

The invention described herein was made with U.S. Government support under subcontract number LS97-00001 under Prime Contract Number DAAM01-97-C-0030 awarded by U.S. Army, SBCCOM, Edgewood, Md. The United States Government has certain rights in the invention.

### TECHNICAL FIELD

This disclosure relates generally to chemical detection and more specifically to the detection of a chemical through signature extraction and classification.

### BACKGROUND

The threat of attack on military and civilian targets employing chemical warfare agents and toxic industrial chemicals is of growing concern. Various technologies to detect and identify such chemicals are currently under development. Standoff chemical detectors are one example of a technology that can identify these chemicals. Standoff chemical detectors allow for real time, on the move detection for contamination avoidance and reconnaissance operations.

### SUMMARY

This disclosure provides a system and method for standoff chemical detection, including the detection of nitric acid.

In one embodiment, a method is disclosed that includes obtaining at least one measurement in a spectral domain of a sample and computing one or more qualities of the measurements in the spectral domain. The computing of the one or more qualities results in at least one peak within the spectral domain. This method also includes comparing the one or more computed qualities against a chemical signature of nitric acid. In addition, this method includes determining if the chemical signature is present in the sample.

In another embodiment, a system is disclosed for detecting a chemical signature that includes a processor for preprocessing an interferogram from received scene spectral information. The processor is configured to extract one or more features from the preprocessed interferogram corresponding to one or more predefined feature templates representative of one or more chemical vapor clouds and to process the features to determine if a chemical signature is present.

In yet another embodiment, a computer readable medium having instructions for causing a processor to perform a method detecting chemical is provided. The method includes receiving an interferogram which captures scene radiance information, performing apodization on the interferogram, and performing a chirp Fast Fourier Transform on the apodized interferogram. This method also includes applying a calibration curve and matching the signatures derived from the corrected spectrum to signatures derived from target chemical templates.

### BRIEF DESCRIPTION OF THE DRAWINGS

For a more complete understanding of this disclosure, reference is now made to the following description, taken in conjunction with the accompanying drawings, in which:

FIG. 1 illustrates an example passive mobile chemical vapor detection system according to one embodiment of this disclosure;

FIG. 2 illustrates an example method of using the passive mobile chemical vapor detection system according to one embodiment of this disclosure;

FIG. 3 illustrates an algorithm used to process interferograms generated by the chemical vapor detection system according to one embodiment of this disclosure;

FIG. 4 illustrates an example method of preprocessing interferograms according to one embodiment of this disclosure;

FIG. 5 illustrates an example system for extracting a feature vector from a normalized spectrum according to one embodiment of this disclosure;

FIGS. 6A, 6B, 6C, and 6D illustrate example representations of a shape template used to represent known peaks and common interferents according to one embodiment of this disclosure;

FIG. 7 illustrates an example block flow diagram of classifying feature vectors to identify chemical vapors according to one embodiment of this disclosure;

FIG. 8 illustrates an example correlation of a plurality of measurements and a plurality frequencies according to one embodiment of this disclosure; and

FIGS. 9A, 9B, 9C, 9D, 9E, and 9F illustrate example peaks and troughs of various spectral domain readings according to one embodiment of this disclosure.

### DETAILED DESCRIPTION

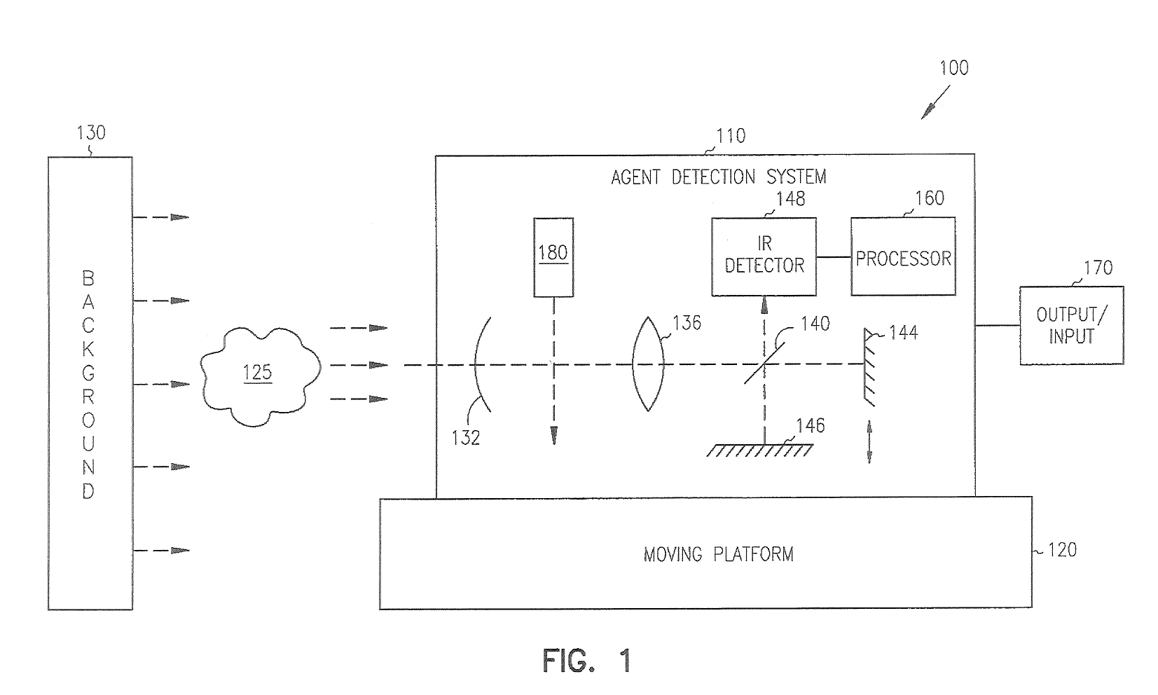

FIGS. 1 through 9F, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system. The functions or algorithms described herein can be implemented in software in some embodiments, where the software comprises computer executable instructions stored on computer readable media such as memory or other type of storage devices. The term “computer readable media” is also used to represent carrier waves on which the software is transmitted. Further, these functions may correspond to modules, which can include software, hardware, firmware, or any combination thereof. Multiple functions can be performed in one or more modules as desired, and the embodiments described are merely examples. Software can be executed on a digital signal processor, ASIC, microprocessor, or other type of processor, such as those operating in a computer system like a personal computer, server, or other computer system.

Nitric acid (HNO₃) is a powerful oxidizing agent that is a highly corrosive and toxic strong acid. Nitric acid is used in a number of industrial and military applications. These military applications include explosives such as nitroglycerin and cyclotrimethylenetrinitramine.

The detection of nitric acid is difficult because of the reactivity of nitric acid, the false positives created by the presence of other compounds in a sample, and the interference caused by other compounds in a sample. These and other technical problems are overcome using feature signatures of nitric acid that has been obtained through measurements in the infrared (IR) spectral domain (hereinafter “spectral domain”). These feature signatures are created from the extracted features of the nitric acid as matched to other near extracted features of typical interferences. While the spectral domain described herein references the IR spectral domain, it is explicitly understood that any domain, including any domain within the electromagnetic spectrum, may be used consistent with this disclosure.

A feature signature refers to a set of one or more feature measurements, for example, amplitude and mse. Feature measurements quantify a chemical signature, which refers to the unique spectral characteristics that a particular compound will have at a given concentration within a frequency band in the spectral domain. A spectral characteristic can represent an emission peak or an absorption trough in the spectral band. Sometimes a spectral characteristic represents a partial peak or trough in a narrower spectral band. This is necessary when part of the peak or trough is affected by system artifacts or common background chemicals. The presence or partial presence of a peak or a trough in a spectral region can be referred to as the presence of a chemical signature. A chemical signature of a target chemical can also represent a spectral band where no peak or trough is present. This is referred to as absence of a chemical signature.

One of the complexities in detecting a chemical is that its spectrum changes based on the characteristics of the chemical cloud and its environment. That is under a specific condition (e.g., a cloud at long distance) the spectrum, thus the chemical, may be represented by only 1 peak (chemical signature). The same chemical, under a different condition, e.g., a cloud at short distance will have a different spectrum, e.g., two representative peaks (chemical signatures). As another example, a spectral peak may become broader and saturated when the concentration of the chemical cloud becomes very high. Hence, a chemical can have multiple sets of chemical signatures. The present disclosure detects a target chemical with multiple sets of chemical signatures.

Salient features are extracted from a chemical signature. One set of chemical signatures is quantified by a set of features. Consequently, a chemical can be represented by multiple sets of feature signatures, each of which corresponds to a set of salient features.

In order to detect the target chemical and the target chemical in the presence of other interfering chemicals while rejecting other interfering chemicals, the target chemical feature signature may be augmented with salient features of selected interfering chemicals. This creates an augmented feature signature of the target chemical. Thus, a target chemical is represented by multiple sets of augmented feature signatures. Each augmented feature signature is classified by the neural net. The target chemical is detected when any one of the augmented feature signatures is classified positively.

The present disclosure uses nitric acid as an example of a material that may be detected using the presently disclosed systems and methods. However, it is explicitly understood that any number of different compounds or elements may be detected using similar methods. Therefore, the present disclosure should not be limited to the detection of nitric acid.

A chemical detection system 100 for use in detecting chemicals is shown in FIG. 1. The system is housed in an enclosure 110 and is mounted on a platform 120, such as a moving vehicle, in this embodiment. The platform can also be stationary at a fixed site. The chemical detection system 100 is used to detect and differentiate chemical vapors 125 by chemical types. The chemicals that may be detected include any type of chemical warfare agents, toxic industrial chemicals, compound, or element with known chemical signatures. It is understood that the chemicals may be detected in various types of backgrounds 130.

One type of chemical detection system utilized employs passive sensing of infrared (IR) emissions. The IR emissions along with background emissions are received through a window 132 mounted in the enclosure 110 and focused by a second lens system 136 onto a beam splitter element 140. Some of the IR is transmitted by a first stationary mirror 144 mounted behind the beam splitter element 140. The rest of the IR is reflected by splitter element 140 onto a moving mirror 146. The reflected beams from the stationary mirror 144 and moving mirror 146 combine to create an interference pattern, which is detected by an IR detector 148. An output of the IR detector 148 is sampled in one of two modes to create an interferogram, which is processed at a processor 160 to provide an output 170 such as a decision regarding whether or not the signatures of the chemical exists.

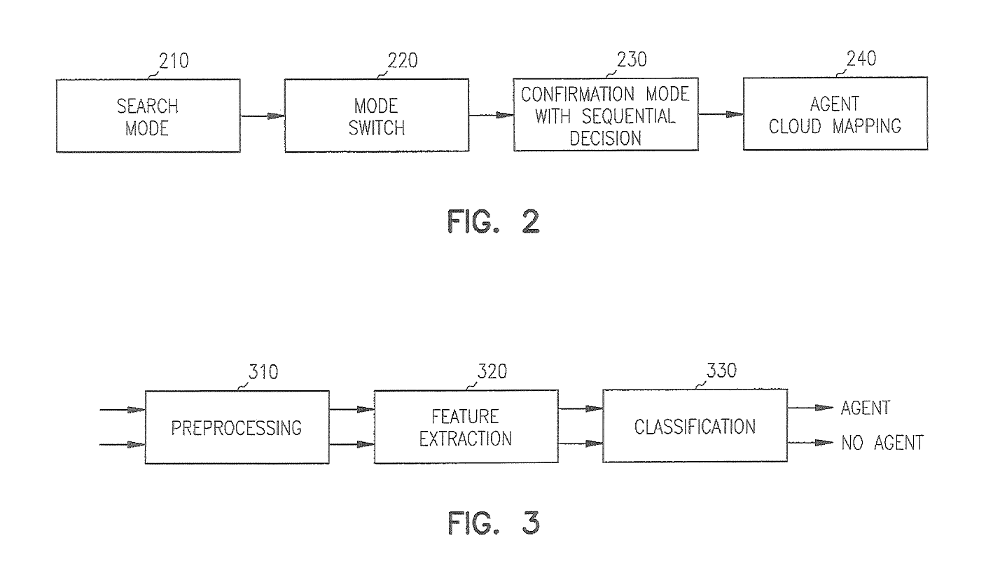

FIG. 2 illustrates one system of searching for a chemical signature. In a search mode (block 210), a reduced resolution is utilized, such as at approximately a 16-wavenumber resolution. This resolution allows for the rapid detection of a chemical signature using either an affirmative component or a negative component. One of the tradeoffs in this 16-wavenumber resolution is that the data acquisition for system 100 is very rapid, albeit at a relatively low resolution.

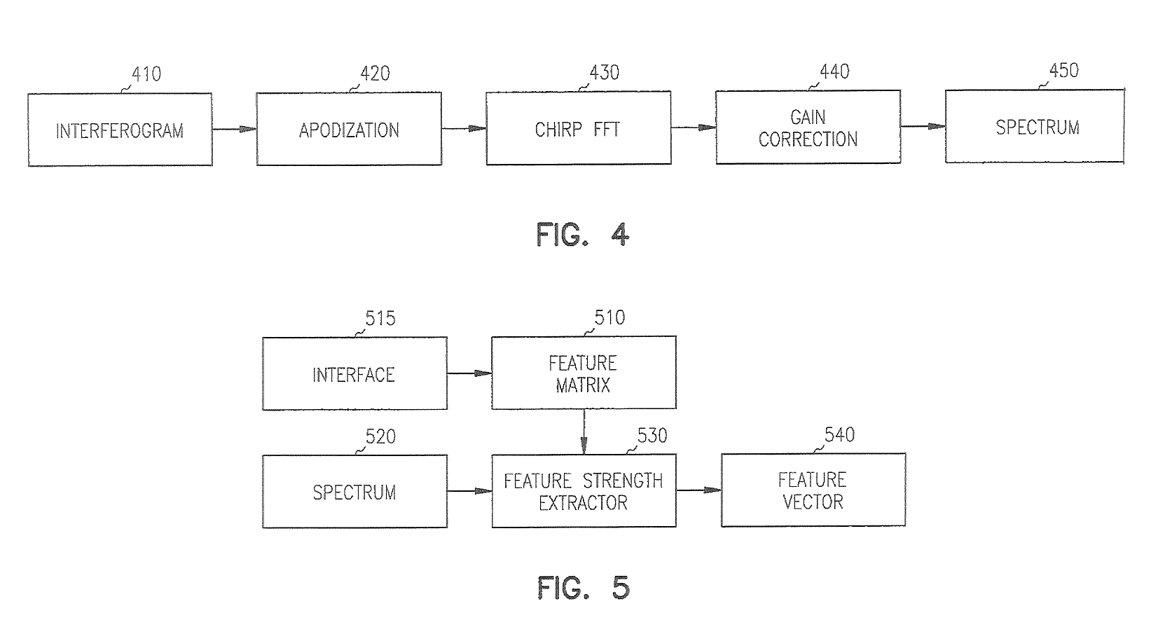

Therefore, when the target chemical is detected at the low resolution mode, the mode is switched (block 220) to a confirmation mode. The confirmation mode identifies the chemical at high resolution followed by sequential decision making (block 230). Sequential decision making determines if the feature signature is present by verifying it is repeatable. If the presence of the feature signature is confirmed, the chemical compound relating to the feature signature is mapped to provide an indication of the location of the chemical compound (block 240). Algorithms are utilized to detect chemicals as shown in FIG. 3.

It is understood that the presently disclosed systems and methods can use the reduced resolution (16 wavenumber) “search mode” and then, upon the detection of part of the chemical signature, switch to a 4-wavenumber resolution “confirm mode”. The time to scan the entire field of range at 4-wavenumber resolution would exceed time constraints in many applications and would not provide enough time to take protective measures or to take evasive action for contamination avoidance. The time to acquire radiometrically equivalent 16-wavenumber resolution data is 16 times less than that for 4-wavenumber resolution data. The 16-wavenumber resolution data does not provide as much detail as the 4-wavenumber resolution data, hence the chemical differentiation and false alarm performances of the 16-wavenumber resolution mode can be poorer than that of the 4-wavenumber resolution mode. Therefore, a dual “search” and “confirmation” mode approach is used in one embodiment, in which the 16- and 4-wavenumber resolution modes are used in concert to meet timing and detection requirements. Of course, given faster measurement systems and processors, a single high-resolution mode approach will be feasible, or a single mode of suitable resolution may be used. The present disclosure is not limited to 4- or 16-wavenumber resolution.

Effectively, the search mode operation detects all regions of interest (ROI) that potentially have chemicals with the known chemical signatures. It may need to do this with a reasonably low rate of false triggers but with the same sensitivity as the confirmation mode because to miss a compound in search-mode would result in the failure to detect the compound. A rule is defined such that the search mode can be switched immediately to confirmation mode without scanning the entire field of range. This happens in the mode switch block 220 when the search mode result reaches a high confidence decision that a chemical cloud is present. Thus, the processing can detect the chemical in the shortest time. The confirmation mode applies a step and stare operation, in which high-resolution (4 cm-1) data is collected and analyzed to confirm the presence of and classify the types of compounds in the field of view. Any false triggers from the search-mode are rejected.

A further challenge is that the algorithms may need to detect down to very low signature strengths that approach the noise level of the system with a very low false alarm rate. The small signal detection capabilities are dictated by the concentration and size of the cloud 125, cloud distance and cloud-to-background temperature difference. Furthermore, the small chemical signal may need to be detected under many variations, which could be due to system-to-system differences or changes in operational environments. For example, the frequency of a laser diode that provides the data sampling reference in the sensor varies slightly from one laser to the next. As a result, the spectral resolution may vary from system to system. As another example, the detector response is affected by temperature, and consequently the spectral characteristics will be affected. Extracting the consistent feature signature amid the noise and signal variations may be critical to the success in the chemical detection.

The confirm mode utilizes a sequential decision process whereby a final detection decision is based on N-out-of-M detections from a sequence of confirm mode scans in the same field of view. When a sequential decision is invoked, the final decision at any instance of time can be one of three: “chemical detected,” “no chemical detected,” or “no final decision yet.” A final “chemical detected” is made only when strong evidence of the chemical is accumulated, such as a majority of the single decisions is consistent. On the other hand, a final decision on “no chemical detected” is made based on very weak or no evidence of chemical presence. Thus, any spurious, single scan, false detection will be rejected. In such cases, the detection cycle returns back to the previous stage. No final decision is made when the number of cumulative detected chemicals does not support nor deny the presence of a chemical. If no final decision is made, additional sequential scans are incorporated until the target chemical or no chemical decision is made. The process rules include an upper bound to the value of ‘M’ as a time constraint. Hence, sequential decision making reduces the false alarm rate and increases the confidence that a chemical is present when the final “chemical detected” decision is made.

Once sequential decision making confirms the presence of a chemical signature, the detection cycle switches to the chemical cloud mapping process (block 240). The chemical cloud mapping process locates the extents of the chemical cloud based on a search pattern.

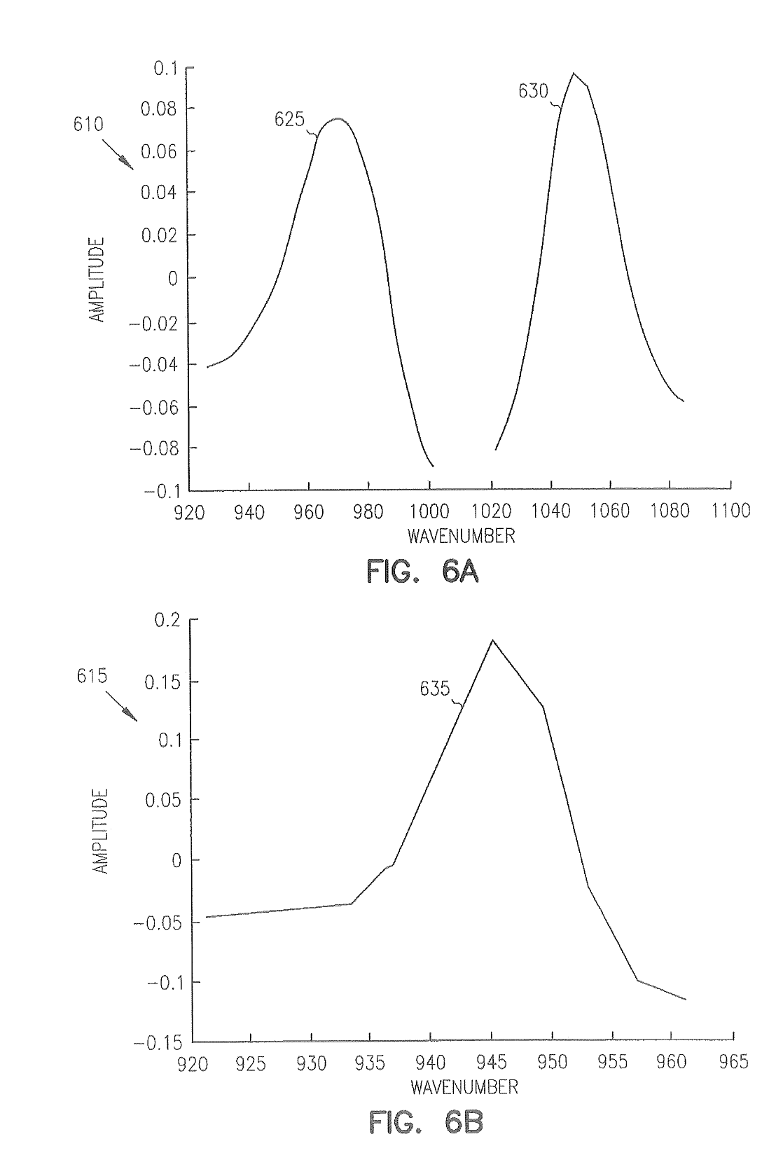

The search and confirmation modes both process interferograms to make a decision on the presence and class of the chemical, if any. Both modes may utilize the same algorithm as shown in FIG. 3, which includes three processes: preprocessing 310, feature extraction 320, and classification 330. Preprocessing 310 transforms the interferograms to the spectral domain and tunes the output to have a common standard free of any sensor and system variation. Feature extraction 320 computes the discriminatory features that are specific to the chemical types, interferents, and backgrounds. Classification 330 determines the classes and types of the chemicals and rejects the interferents and backgrounds. The input data to the two modes differ in resolution. Accordingly, the parameters of the algorithms in the two modes also differ. Details of the preprocessing, feature extraction and classification are described with reference to FIGS. 4-9 below.

Preprocessing 310, the first stage of the detection algorithm, transforms measured interferograms 410 into spectra as illustrated in FIG. 4. The preprocessing stage compensates for any system-to-system variations and drift in time so that the resulting measurement artifacts can be ignored in subsequent algorithm stages. The artifacts that are specifically compensated for are frequency-dependent gain, interferogram centerburst position, and spectral resolution. The compensation factors are derived from factory calibration, and calibration functions that are executed at timed intervals, such as every 10 minutes, while in use. One artifact that is not compensated for in the preprocessing stage is the signal-to-noise ratio (SNR) in the spectrum. SNR is addressed in a subsequent stage.

The preprocessing stage also includes the following functions as shown in FIG. 4. Apodization of the asymmetric interferogram at 420 multiplies the interferogram with a window function shown. Apodization removes antialiasing due to asymmetry consistent with the well-known Mertz method of processing interferograms.

A chirp-Fast Fourier Transform (FFT) converts spectra to an identical frequency comb of 4-wavenumbers for all systems at 430. Each sensor may have a different sampling reference. The chirp-FFT allows sampling of data at selected frequencies and interpolates to a selected frequency comb to calibrate between the sensors.

Frequency dependent gain/offset correction is applied at 440 to provide a spectrum comprising amplitude for each wavenumber at 450. The gain/offset correction is derived from a calibration process. In FIG. 1, a known IR source 180 is periodically inserted between the window 132 and second lens system 136 to block out all ambient IR and provide a known IR radiation. Gain and offset are calculated that result in an output spectrum matching the source 180, such as a smooth black body. In one embodiment, two known sources represented by source 180 are utilized to determine the gain and offset correction. In a further embodiment, one source is used, and values for a second source are estimated.

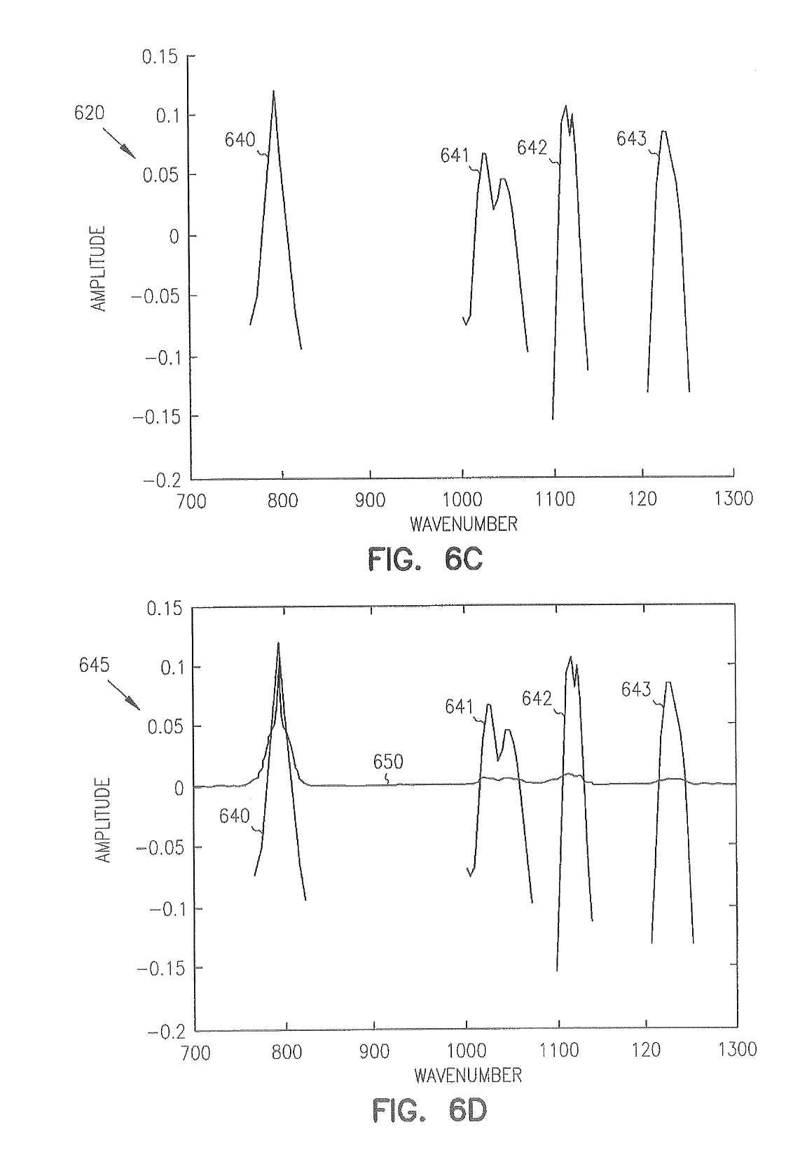

The feature extraction stage is shown in FIG. 5 and transforms each spectrum output 520 by the preprocessor into a vector of salient features 540 for a following classifier stage. The goal of the feature extractor 530 is to 1) reduce the quantity of data that must be passed to a classifier for each scene, and 2) transform the scene spectrum to a representation where classification is simpler.

In one embodiment, the spectrum output 520 first undergoes a normalization process, wherein the spectrum output 520 is divided by a Planck's function whose temperature is estimated from several points of the spectrum output 520. The output is a normalized spectrum, which has peaks and valleys around nominal values of one.

The feature extractor is designed to be sensitive to peaks and valleys in the spectrum. When the system is aimed at a blackbody scene, all elements in the resulting feature vector are zero except for noise. Warm chemical clouds relative to the scene produce emission peaks in the spectrum and corresponding positive amplitude feature vector elements. Cool chemical clouds produce absorption valleys and negative amplitude feature elements. Each feature measurement in the feature signature is extracted from the spectrum by a match filter that has been tailored to a particular peak in the absorption coefficient curve of a chemical or common interferent. Thus, each feature in the feature signature characterizes the peak or valley in the scene spectrum at a frequency band with a shape that corresponds to a known chemical/interferent absorption phenomenon.

The match filters utilized by the feature extractor 530 are selected using a heuristic approach with the objective of maximizing detection sensitivity and discriminating capability. An initial set of potential match filters is derived from the target chemical and interferent absorption coefficient curves in the frequency range of interest. This initial set consists of several hundred potential match filters. The most prominent match filters from each target chemical are chosen since these provide the greatest detection sensitivity relative to the noise in the system. Some prominent interferent match filters are also chosen because these can sometimes provide discriminating capability. Typically, a set of 20 to 40 match filters are selected and packaged into a feature matrix 510 that can be loaded into the system via an interface 515.

The feature extractor 530 produces a discriminating feature signature 540. For the subset of scenes that are relatively simple—a target chemical or interferent cloud against a relatively benign background, a chemical decision can be made based on a threshold on the feature signature. For more complex scenes, with multiple target chemicals and/or interferents and feature-rich backgrounds, a further classifier stage described below is utilized.

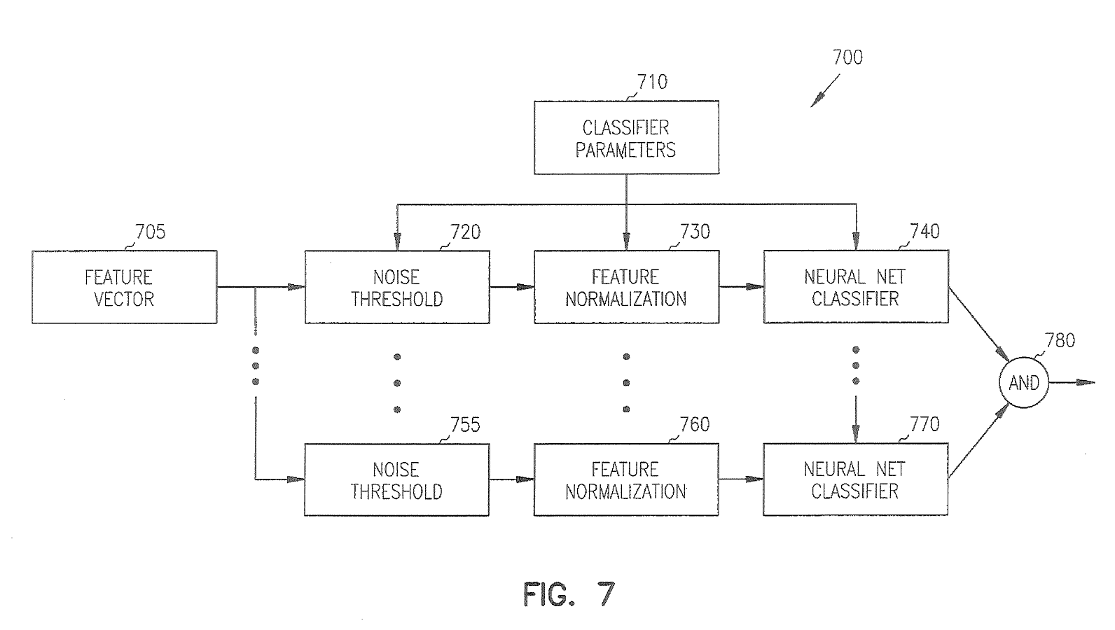

FIGS. 6A, 6B, 6C and 6D illustrate several filters, or templates of characteristic spectral bands for known chemicals based on their absorption coefficient curves. Multiple filters for different or the same chemical is shown in templates 610, 615, and 620. The first template 610 comprises two peaks indicated at 625 and 630. Both the height and shape of the curves is representative of the potential chemical. Template 615 comprises a curve 63 5, and template 620 comprises four curves 640, 641, 642, and 643, both of which are representative of chemicals both by amplitude and shape. Curve 641 and 642 contain a double peak, a small amplitude peak immediately followed by a larger amplitude peak.

Template 645 illustrates matching of template 620 to detected spectra. Curves 640, 641, 642, and 643 are shown superimposed on the graph with spectral band from the normalized spectra 650. A least squares fit algorithm is applied to determine matches. The fit algorithm computes amplitude, slope, offset, mean square error of fit (mse), and skew of the fit between the template and the spectral region. Given a shape template, S, whose first and second moment are zero, and the corresponding spectral region, Y, (both Y and S are vectors of length n), the amplitude, slope, offset, and mse are computed as follow:

amplitude=Y.S′

slope=Y′.L

offset=mean(Y)

mse=square_root(((P(i)−Y(i))2)/n)

where:

L=(L0−mean(L0))/norm(L0−mean(L0);
L0 is a vector equals to 1, 2, . . . , n

P=offset*U+slope*L+amplitude*S/S(i)2; and
U is a vector whose n elements equal to 1.

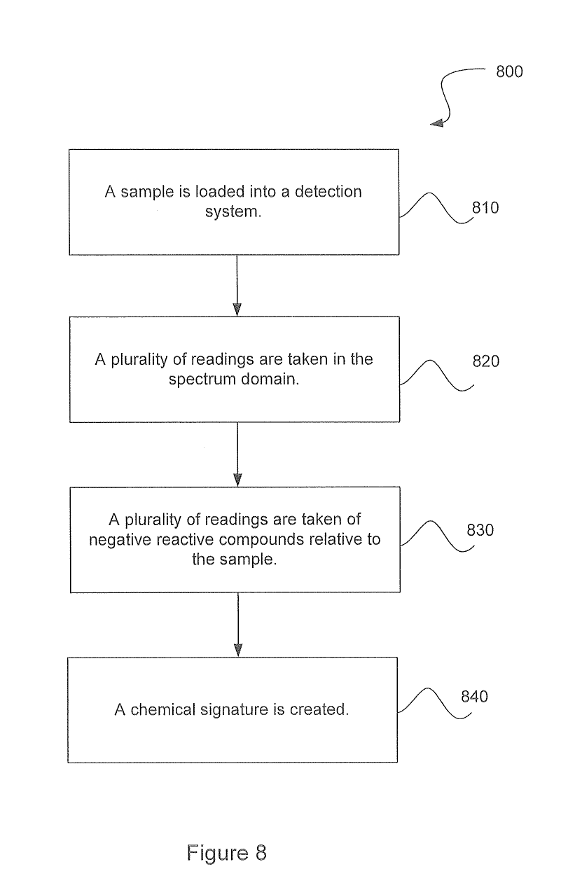

The third stage of the detection algorithm is the classification algorithm 700, as shown in FIG. 7. The main objective of this stage is to classify the extracted feature signature 540 into one or more classes; each class indicates the presence of the associated class target chemical or the no-chemical class. The classifier's challenge is to detect a chemical under emission as well as absorption conditions, and in the presence of different interferents and backgrounds. In this case, the classifier has to map different feature signatures in order to classify the interferogram properly.

The feature signatures is represented at 705 in FIG. 7. A plurality of classifier predetermined parameters for chemicals are illustrated at 710, and are used to tailor the algorithm to detect the chemicals. The parameters are provided to a plurality of algorithms comprising feature indices for each classifier, noise threshold 720, feature normalization 730 and neural net classifier 740. Each of these algorithms is duplicated for each different feature signature to be detected, as indicated with dots, and blocks 755, 760 and 770. It is understood that in some embodiments, each target chemical may be classified by multiple feature signatures. The classifier parameters 710 are used to program each of the sets of algorithms based on extensive training and heuristic data.

The first process of the classifier is a preconditioning step, where the classifier performs a normalization step process 730 . . . 760 to be able to detect or classify a wider range of chemical signatures. In one embodiment, the normalization step is an option determined by a parameter in the classifier parameters 710. Also involved is a noise threshold test 720 . . . 755, which measures and removes very weak signals. The measure is a weighed sum of features that are predefined for each target chemical classifier, and is compared with a threshold. This threshold is adaptively set according to minimum detection requirements for each target chemical, the false alarm requirements and the SNR for the system in operation. When the measure does not exceed the threshold, a weak signal and no-chemical detection for that target chemical classifier is declared without exercising that feature signature neural network.

The classification algorithm may be implemented through a neural network bank 740 . . . 770, in which each of the neural networks is trained to detect a particular feature signature corresponding to a target chemical and reject other non-similar target chemicals, different interferents and background signatures. The neural network is based on the backpropagation architecture with one hidden layer. The size of the hidden layer was carefully chosen in order to classify the target chemical under different scenarios and not over generalize the detection scheme. An output threshold 780 is associated with each neural network that is tuned based on detection performance and false alarm rate. Since there are usually multiple templates per target chemical deriving the key discriminating features for that target chemical, not all of the feature measurements computed in the feature extraction process need be run through the neural network for it to arrive at the target chemical decision. The selected feature indices for each classifier are stored in the classifier parameters 710. While a neural network is shown in FIG. 7, it is expressly understood that any type of software, including artificial intelligence software, may be used.

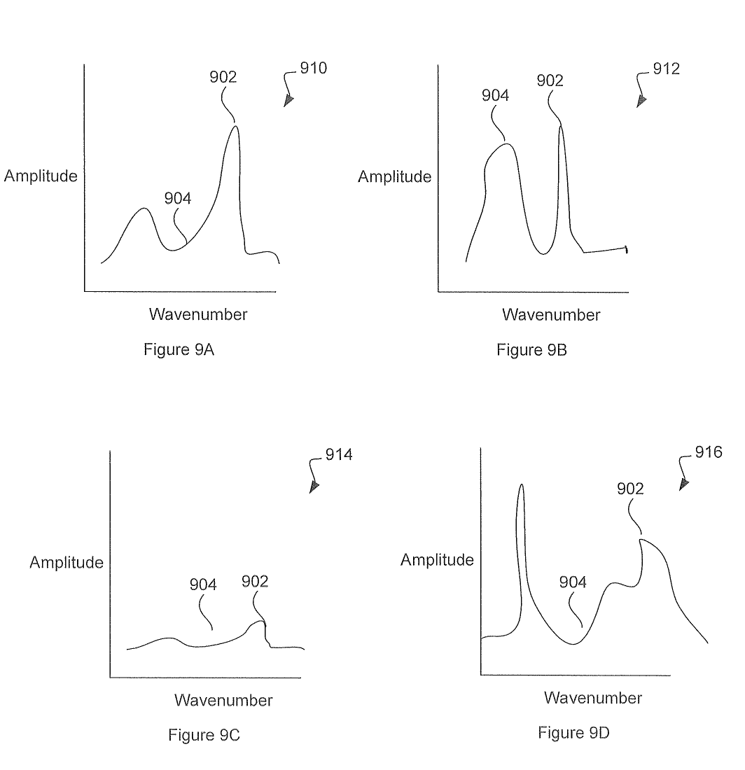

FIG. 8 is a block diagram illustrating the creation of a feature signature according to one embodiment of the present disclosure. In block 810, a spectrum of the target chemical, which is simulated from its absorption coefficients, is loaded into system 100. In block 820, a plurality of spectra is simulated in the spectral domain based on the different cloud conditions, presence of interferents and backgrounds. In block 830,the distinct chemical signatures among the simulated spectra and the key features of each chemical signature are identified. In block 840, a feature signature is created that is composed from the collection of features obtained in block 830.

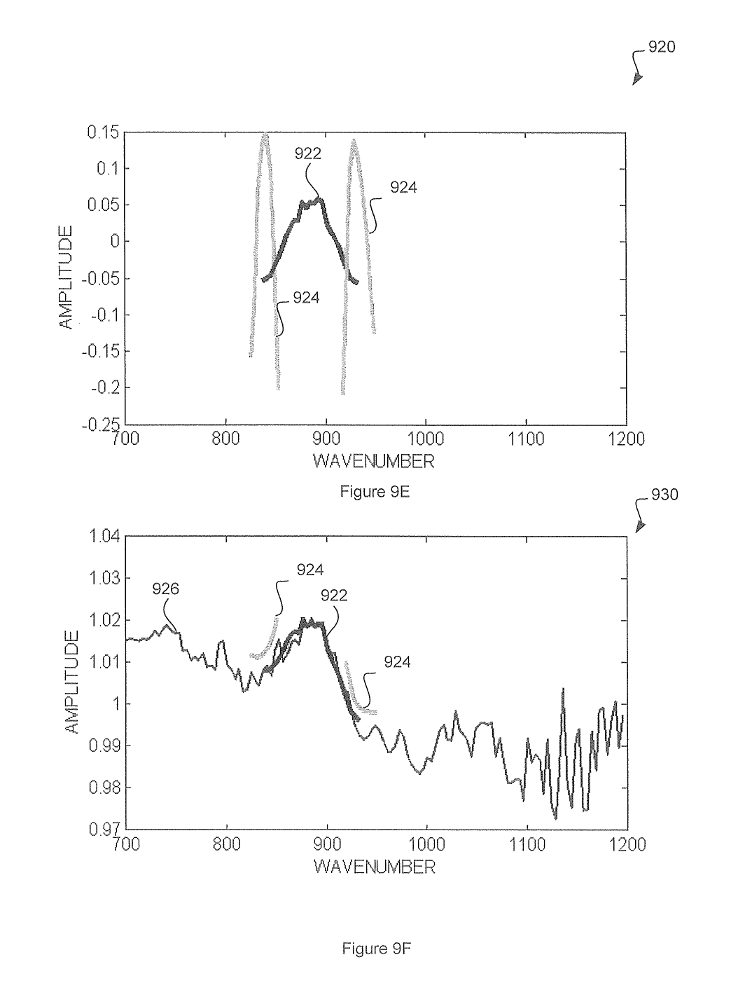

FIGS. 9A, 9B, 9C, and 9D are all demonstrative of readings obtained by system 100. FIG. 9A illustrates the profile of a compound with a chemical signature. In this example 910, the chemical compound has a two-part signature comprising a peak at 902 and a trough at 904. FIG. 9B is an example 912 of a chemical that does not have the chemical signature because it has peaks at both 902 and 904. FIG. 9C is another example 914 of a chemical that does not have the chemical signature because it has troughs at both 902 and 904. FIG. 9D is an example 916 of a compound that has the chemical signature as it has a peak at 902 and a trough at 904. The examples shown in FIGS. 9A-D are a simplification of the chemical signatures, and are shown only for the purpose that both presence and absence of a chemical signature may be used to detect a chemical.

FIG. 9E are example templates that may be used to detect nitric acid. Curve 922 is the match filter template designed to detect the primary peak for nitric acid. Curves 924 are match filter templates that may be used to detect that the primary peak returns to a baseline on either side. To optimize the efficiency of the feature extraction module in one embodiment, each match filter template is created with zero offset, zero slope, and is normalized. It is understood that a plurality of match filters may be used to detect the primary peak of nitric acid or any other substance. Furthermore, each of these match filters is capable of extracting several values in the feature vector from a sample spectrum: amplitude, slope, offset, mean square error of fit (mse).

FIG. 9F is an example of applying the match filters 922 and 924 to a sample input spectrum, curve 926, that contains Nitric Acid and some common atmospheric constituents (water, ozone, CO2). The templates have been scaled, offset and tilted to show how well they match the sample spectrum. Curves 924 have been offset slightly from their optimal offset to make them more visible. It is understood that a plurality of match filters may be used to detect the primary peak of nitric acid or any other substance. Therefore, when curves 922 and 924 are used and detect a primary peak, it is the absolute and relative values of the feature vector values extracted by these templates that indicate nitric acid may be present. In FIG. 9F, curve 922 detects a modest-amplitude positive peak is present that is a good fit with nitric acid (low mse) and with modest slope. Curves 924 detect that the peak returns to a baseline on either side with appropriate negative amplitudes relative to the positive peak detected by curve 922.

It is understood that FIGS. 9E and 9F are for exemplary purposes.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining at least one measurement of a sample, wherein the at least one measurement is obtained from at least one range within a spectral domain;
computing at least one feature signature of the sample in the spectral domain;
classifying the at least one computed feature signature using at least one known chemical signature, wherein the known chemical signature comprises at least one characteristic of a known chemical in the spectral domain; and
determining if the at least one known chemical is present in the sample using the at least one feature signature derived from the at least one known chemical signature.

2. The method of claim 1, wherein classifying the one or more computed feature further comprises:
classifying the one or more computed features of the sample against both the presence and absence of the at least one feature of the known chemical signature.

3. The method of claim 1, wherein the computing of the one or more features uses a means square function.

4. The method of claim 3, further comprising:
comparing the sample against a feature signature of nitric acid.

5. The method of claim 1, further comprising:
identifying one or more features of a chemical signature from a known sample.

6. The method of claim 5, wherein identifying the chemical signature for the known sample comprises determining one or more shapes within specific spectral ranges for the chemical.

7. The method of claim 1, wherein the one or more salient features are processed by a neural network.

8. The method of claim 7, wherein a plurality of nodes within the neural network are each assigned a separate feature.

9. The method of claim 8, wherein the classifying is performed using a least squares fit algorithm.

10. The method of claim 1, wherein the features are selected from the group of at least one: amplitude, slope, offset, mean square error of fit, and skew of fit.

11. The method of claim 1, further comprising:
operating in search and confirm modes, wherein the search and confirm modes have different spectral resolutions.

12. The method of claim 11, wherein the search mode is optimized for speed the confirm is optimized for accuracy.

13. A system for detecting a chemical, comprising:
a processor for preprocessing an interferogram from a received scene spectral information, wherein the processor in configured to:
extract one or more salient features from the preprocessed interferogram corresponding to one or more predefined feature templates representative of one or more chemical vapor clouds; and
classify the features to determine if a chemical is present.

14. The system of claim 13, wherein the processor comprises a plurality of neural nets, each corresponding to one chemical.

15. The system of claim 14, wherein the neural nets are trained iteratively employing one or more random training subsets of data from a large training set.

16. The system of claim 15, wherein the random training subsets further include problematic data from previous random subsets.

17. A computer readable medium having instructions for causing a processor to perform a method detecting chemicals, the method comprising:
receiving an interferogram from a sensed spectral information;
performing apodization on the interferogram;
performing a chirp Fast Fourier Transform on the apodized interferogram;
applying a calibration curve; and
matching the corrected spectrum to selected chemical signatures of a chemical compound.

18. The computer readable medium of claim 17, wherein the method further comprises:
loading at least a second chemical signatures for a second chemical compound.

19. The computer readable medium of claim 18, wherein the method further comprises:
transmitting an alert based upon a detection of the target chemical.

20. The computer readable medium of claim 18, wherein the chemical signatures is for nitric acid.
